(19) United States
(12) Patent Application Publication
(10) Pub. No.: US 2014/0226973 A1
(43) Pub. Date: Aug. 14, 2014

(54) System and Method for Isolating RF Signals for Transmission Over Multiple Channels on a Single Transmission Path

(71) Applicants: Peter H. Wolff, Apollo Beach, FL (US); Chen-Kuo Sun, Escondido, CA (US); Eric Liu, Fremont, CA (US)

(72) Inventors: Peter H. Wolff, Apollo Beach, FL (US); Chen-Kuo Sun, Escondido, CA (US); Eric Liu, Fremont, CA (US)

(21) Appl. No.: 13/764,561

(22) Filed: Feb. 11, 2013

(51) Int. Cl. H04B 10/2575; H04B 10/079

(52) U.S. Cl. CPC H04B 10/2575; H04B 10/0795
USPC 398/25; 398/116

(57) ABSTRACT

A system for regulating the signal strengths of a plurality of Radio Frequency (RF) signals to reduce signal degradation includes a plurality of controllers. Each controller is operably positioned upstream of an electrical-to-optical converter which generates an optical signal for transmission over a fiber optic transmission path. Each controller functions to detect and identify RF signals whose strength exceeds a maximum value and immediately attenuate the RF signal to prevent the transmission path from being jammed by the signal. Each controller also performs a signal leveling function by sampling signal strength, over time, and uses moving window averaging or some other moving window statistic to level the RF signal. Structurally, each controller includes a detector, a signal attenuator and a signal amplifier that are operationally positioned along a signal path extending from a controller input port to a controller output port and are operationally connected to a processor.

### FIELD OF THE INVENTION

The present invention pertains generally to devices in which a plurality of Radio Frequency (RF) signals are converted into an optical beam for transport over an optical fiber. More particularly, the present invention pertains to systems and methods for reducing interference between RF signals within a device which converts the RF signals to an optical signal for transport over an optical fiber. The present invention is particularly, but not exclusively, useful for systems and methods that maintain an optimal power level for each individual RF signal in a plurality of different RF signals to reduce signal degradation due to interference between the RF signals.

### BACKGROUND OF THE INVENTION

Modernly, there is a need to transport digitally encoded information, such as video, voice and data signals, over relatively long distances using, for example, passive optical network (PON) or point-to-point network topologies. In this regard, optical fibers can be used to transport signals over relatively long distances with relatively low signal distortion or attenuation, as compared with copper wire or co-axial cables.

One way to transport digital information across an optical fiber is to modulate a digital signal on an analog carrier signal to create an RF signal using a modem. In many applications a plurality of digital signals are modulated to create a plurality of corresponding RF signals and then the RF signals are combined. Next, the combined RF signal can be converted into a light beam signal using an optical transmitter such as a laser diode, and introduced into an end of an optical fiber. During this process, the RF signals can interfere with one another leading to signal degradation. In particular, the signal degradation is often more pronounced when the signals have different strengths. For example, a relatively strong RF signal can degrade (i.e. jam) a relatively weak RF signal.

In light of the above, it is an object of the present invention to provide a system and method for optically transporting a plurality of digital signals on an optical fiber transmission path over distances greater than about 1 km with little or no signal degradation. Another object of the present invention is to provide a system and method for achieving an optimal power level for each individual RF signal in a plurality of different RF signals. Still another object of the present invention is to provide a system and method for detecting and isolating noise sources during simultaneous transmission of a plurality of RF signals. Still another object of the present invention is to provide a system and method for isolating RF signals for transmission over multiple channels on a single transmission path that are easy to use, relatively easy to manufacture, and comparatively cost effective.

### SUMMARY OF THE INVENTION

In accordance with the present invention, a system for regulating the signal strengths of a plurality of RF signals includes a plurality of controllers. For the system, the controllers are positioned to adjust the signal strengths of the RF signals upstream of a location where the RF signals are converted to an optical signal and transmitted over a fiber optic transmission path. More specifically, each controller receives and operates on an input RF signal from a source such as a modem. It is envisioned for the present invention that the signal strength of each input RF signal may vary over time. Moreover, at any one time, the signal strength of the RF signal that is input at one controller may differ considerably from the signal strength of the RF signal that is input at another controller.

The overall functionality of the controller is two-fold. First, the controller functions to detect and identify RF signals whose strength exceeds a maximum value. Once detected, these strong signals are immediately attenuated to prevent the transmission path from being jammed by the strong signal. With the jamming signals eliminated, the controller can perform a second function, namely, signal leveling. During signal leveling, the controller functions to maintain the signal strength exiting the controller at or near a predetermined value (i.e. set point). To optimize a transmission of several RF signals, different controllers within the system may be pre-programmed with different set points, or, all of the controllers may be pre-programmed with the same set point. In one implementation, the controller can sample the signal strength of an input RF signal over time and use moving window averaging or some other moving window statistic to level the RF signal.

In more structural detail, each controller can include an input port for receiving an input RF signal, and an output port. RF signals exiting the output port of the controller are directed to an electrical-to-optical converter which converts the RF signal(s) to an optical signal for transmission over the transmission path of the fiber optic.

For the present invention, a detector, a signal attenuator and a signal amplifier are operationally positioned along a signal path that extends from the controller's input port to the controller's output port. An optional ON/OFF switch can also be operably positioned on the signal path. For the system, each controller can also include a processor that is connected to the detector, the attenuator, the amplifier, and in some cases, an optional ON/OFF switch. In particular, the processor is connected to receive a signal from the detector that is indicative of RF signal strength, processes the detector signal to produce a processor result and, based on the processor result, send a control signal to the attenuator, amplifier or ON/OFF switch. For this purpose, the processor of each controller can also receive and store user inputs including set points, window parameters and instructions for calculating and comparing the statistics used for leveling. In some cases, some or all of the system's controllers may share a common processor.

In operation, two or more controllers of the system each receive a respective RF signal at the controller's input port from at least one source such as a modem. At each controller, the respective input RF signal passes through a detector which outputs a signal, either periodically or continuously, that is indicative of the signal strength of the RF signal. The detector signal is received by the processor which functions to identify jamming signals and, for the case where the input RF signal is a jamming signal, to provide an immediate control signal to the attenuator to attenuate the input RF signal.

In more detail, the controller can be preprogrammed with a set point corresponding to a predetermined signal strength value for the input RF signal and an upper threshold value “+Δ_{threshold}”. Typically, the predetermined signal strength value for each controller is established to optimize the transference of all signals along the transmission path and reduce interference between RF signals. With access to the pre-programmed set point, the processor can calculate a “Δ” between the signal strength of the input RF signal and the set point. The processor can then determine whether the calculated “Δ” exceeds the upper threshold value “+Δ_{threshold}”. If it does, the processor outputs a control signal to the attenuator to immediately reduce the signal strength of the input RF signal.

A similar process can be implemented to immediately amplify weak RF signals having a signal strength below a minimum value. In more detail, the controller can be preprogrammed with a set point corresponding to a predetermined signal strength value for the input RF signal and a lower threshold value “−Δ_{threshold}”. The processor then calculates a “Δ” between the signal strength of the input RF signal and the set point and determines whether the calculated “Δ” falls below the lower threshold value “−Δ_{threshold}”. If it does, the processor outputs a control signal to the signal amplifier to immediately increase the signal strength of the input RF signal.

During the signal leveling operation, the controller processes the signal from the detector producing a processor result. Then, based on the processor result, the processor outputs a control signal to the signal attenuator or signal amplifier, as required, to maintain the signal strength exiting the controller at or near a predetermined value (i.e. set point). As indicated above and explained in more detail below, the controller can sample the signal strength of an input RF signal, over time, and use a processing technique such as moving window averaging, or some other moving window statistic, to generate the appropriate control signals to the amplifier and/or attenuator for leveling the RF signal.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic presentation of components for a system of the present invention to isolate Radio Frequency (RF) signals for transmission over multiple channels on a single fiber optic transmission path;

FIG. 2 is a schematic presentation of components of a controller for use in the system shown in FIG. 1;

FIG. 3 is a functional flow chart for the operation of a signal strength controller in accordance with the present invention; and

FIG. 4 is a chart showing signal strength as a function of time and illustrating the operation of the controller shown in FIG. 3 on an input RF signal that exceeds a predetermined maximum value.

### DESCRIPTION OF THE PREFERRED EMBODIMENTS

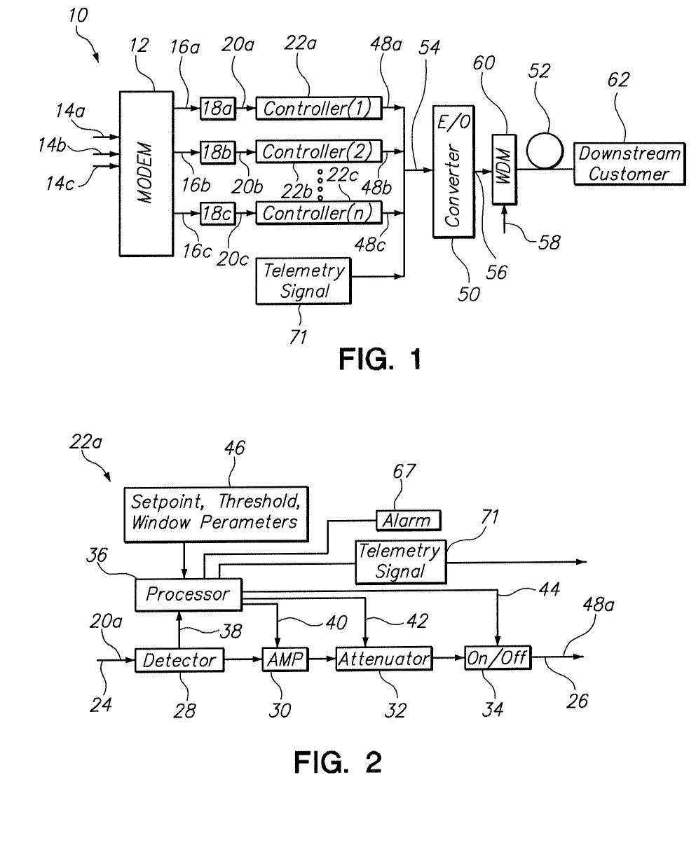

Referring initially to FIG. 1, a system for transporting digital signals is shown and is generally designated 10. As shown, the system 10 includes an RF signal source 12 that is operationally connected to receive a plurality of data streams 14a-c, which may be digital and/or analog signals. For example, the data streams 14a-c can include audio and video signals or computer signals such as computer files or instructions and/or digital signals from other nodes in a communication network. For example, the source 12 can be a modem or cable modem termination system (CMTS) and can include one or more functions such as data filtering and traffic management, data encoding/decoding, data switching, data routing, modulation/demodulation of digital signals onto respective RF carrier signals and signal frequency up-converting/down-converting. For the system 10, the output of the source 12 is a plurality of RF signals 16a-c.

FIG. 1 further shows that a plurality of optional up-converters 18a-c can be provided, with one up-converter 18a-c for each of the RF signals 16a-c. Functionally, the up-converters 18a-c can be used to up-convert the RF signals 16a-c such that when the RF signals 16a-c are combined, either as a combined RF signal or a combined light beam, the combined signal is sub-octave. With this arrangement, second order distortions generated during transmission of a combined optical signal along an optical fiber can be reduced, and in some cases, eliminated. In more detail, each up-converter 18a-c operates on a respective RF signal 16a-c to output an RF signal 20a-c having a frequency band including a frequency that is greater than the carrier frequency (F₀) of the input RF signals 16a-c. For example, the up-converter 18a operates on an RF signal 16a to output a frequency band that includes the frequency (F₁), the up-converter 18b operates on an RF signal 16b to output a frequency band that includes the frequency (F₂), and so on, with the n^{th} up-converter operating on an n^{th} RF signal to output a frequency band that includes the frequency (Fₙ). Moreover, the “n” frequency bands output by the “n” up-converters (and filters in some cases) are non-overlapping and are spaced apart within a single sub-octave. Thus, all of the frequencies output by the up-converters 18a-c reside within a frequency spectrum between f_{L} and f_{H}, where 2f_{L}−f_{H}>0. Further details regarding the use of sub-octave signals to reduce or eliminate second order distortions generated during transmission of a combined optical signal along an optical fiber can be found in U.S. patent application Ser. No. 12/980,008, titled “Passive Optical Network with Sub-Octave Transmission,” to Chen-Kuo Sun, filed on Dec. 28, 2010; U.S. patent application Ser. No. 13/585,653, titled “System Using Frequency Conversions for Sub-Octave Transmission of Signals Over a Fiber Optic,” to Chen-Kuo Sun, filed on Aug. 14, 2012; and U.S. patent application Ser. No. 13/045,250, titled “Sub-Octave RF Stacking for Optical Transport and De-Stacking for Distribution,” to Chen-Kuo Sun,” filed on Mar. 10, 2011, the entire contents of each of which are hereby incorporated by reference herein.

Continuing with FIG. 1, it can be seen that the system 10 includes a plurality of controllers 22a-c, with one controller for each input RF signal 20a-c. As discussed above, it is envisioned for the system 10 that the signal strength of each input RF signal 20a-c may vary over time, and/or, at any one time, the signal strength of an RF signal such as RF signal 20a that is input at controller 22a may differ considerably from the signal strength of another RF signal such as RF signal 20b that is input at controller 22b. Moreover, it is contemplated that regulating and/or optimizing the signal strengths of the individual input RF signals 20a-c by the system 10 will result in the transmission of a combined signal/light beam including all of the RF signals 20a-c with reduced signal degradation (compared to a system with unregulated signal strengths). Although FIG. 1 shows the controllers 22a-c positioned downstream of the optional up-convertors 18a-c, it is to be appreciated that the controllers 22a-c could be positioned upstream of the optional up-convertors 18a-c (alternative embodiment not shown).

FIG. 2 shows the components of a controller 22a. As shown, the controller 22a can include a controller input port 24 for receiving input RF signal 20a and a controller output port 26. FIG. 2 further shows that an RF signal strength detector 28, an RF signal amplifier 30, an RF variable attenuator 32 and optional ON/OFF switch 34 are operationally positioned along a signal path that extends from the controller's input port 24 to the controller's output port 26. The controller 22a can also include a processor 36 that is connected to the detector 28 via line 38, the attenuator 32 via line 40, the amplifier 30 via line 42 and ON/OFF switch 34 via line 44. With this arrangement, the controller 22a can be used to detect and isolate ingress or other noise sources on an RF channel remotely.

For the controller 22a, the detector 28 can be, for example, a through-line RF power meter providing a signal on line 38 that is indicative of RF signal strength. The detector 28 can provide the signal on line 38 continuously or at discrete intervals. As shown, the signal from the detector 28 on line 38 is received and processed by the processor 36. For example, the processor 36 can include a microprocessor, PC based processor, a logic circuit or any other type of processor known in the pertinent art for processing machine readable instructions and data. The processor 36 shown may serve one, some or all of the controllers 22a-c shown in FIG. 1. Computer readable instructions for processing the detector signal can be programmed into memory by a user and used by the processor 36. In addition, as shown, user inputs 46, including set points, thresholds, maximum strength values, window parameters, such as window length and start times, and details for calculating and using statistics for leveling, can be input into computer memory that is accessible by the processor 36.

For the controller 22a shown in FIG. 2, the processor 36 can use preprogrammed instructions, e.g. software code, to process the detector signal (line 38) and user inputs 46 to produce a processor result. Based on the processor result, the processor 36 can send a control signal to the attenuator 32 (line 42), amplifier 30 (line 40) or ON/OFF switch 34 (line 44). Provisions can also be provided in the processor 36 to allow for manual control of the RF signal amplifier 30, an RF variable attenuator 32 and/or ON/OFF switch 34, for example, to conduct factory testing or other testing purposes.

FIG. 2 also shows that the input RF signal 20a enters the controller 22a at input port 24, travels along the signal path that extends from the controller's input port 24 to the controller's output port 26 and exits the controller 22a as an adjusted RF signal 48a.

Cross referencing FIGS. 1 and 2, it can be seen that the adjusted RF signals 48a-c from the controllers 22a-c are directed to an electrical-to-optical converter 50 which converts the adjusted RF signal(s) 48a-c to an optical signal for transmission over a transmission path of the fiber optic 52. For the system 10, the adjusted RF signals 48a-c can be combined into a combined RF signal 54, as shown, prior to input to the electrical-to-optical converter 50, or each of the adjusted RF signals 48a-c can be converted to an optical signal or beam and the optical signals/beams can be directed onto a common fiber optic 52. In either case, the beam 56 exiting the electrical-to-optical converter 50 can be combined with one or more light beams 58 from other systems (not shown) at the optional Wavelength Division Multiplexer 60. The optical signal on fiber optic 52 can be transmitted to a downstream customer 62, as shown, or any other network node or termination known in the pertinent art. Moreover, upstream signals from the customer 62, network node or termination can be transmitted to the system 10 using a different wavelength than beam 56. The upstream signal can be separated (not shown) at the Wavelength Division Multiplexer 60 and routed, for example, to the source 12.

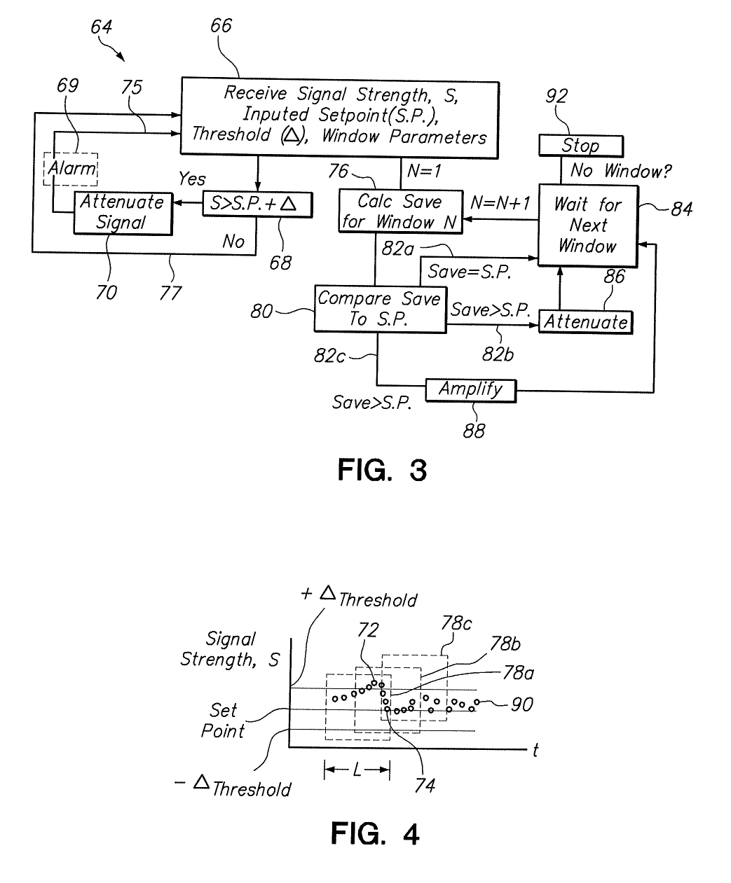

FIGS. 3 and 4 illustrate an operation of the controller 22a shown in FIG. 2. Specifically, FIG. 3 is a flow chart 64 illustrating a sequence of steps that can be performed by the processor 36 (FIG. 3) during an operation of the controller 22a. As indicated above, this sequence of steps can be programmed into machine readable instructions and stored in processor accessible memory. FIG. 4 shows an adjustment of an RF signal passing through the controller 22a.

As shown in FIG. 3, the flow chart 64 begins by storing user inputs and signal strength data from the detector 28 (FIG. 2) into computer readable memory that is accessible by the processor 36 (Step 66). The user input can include set points, thresholds, maximum strength values, window parameters such as window length and start times, and/or details for calculating and using statistics for leveling. Step 68 shows that the processor 36 (FIG. 2) can function to identify jamming signals by comparing the signal strength, S, from the detector 28 (FIG. 2) to a selected maximum strength value which in this case is the set point plus threshold. Step 70 of the flow chart 64 shows that when the signal strength, S, exceeds the set point plus threshold, a control signal is sent to the attenuator 32 (FIG. 2) to attenuate the input RF signal 20a (FIG. 2).

The attenuation of an RF signal is shown in FIG. 4. As shown there, when the signal strength exceeds the set point plus threshold (sample point 72), the signal is immediately attenuated (sample point 74). Once the strong signal is attenuated below set point plus threshold, line 75 in flow chart 64 (FIG. 3) shows that the signal strength, S, is subsequently monitored and compared (Steps 66 and 68). If a subsequent monitoring indicates that the signal strength exceeds the set point plus threshold, the signal is immediately attenuated (Step 70); otherwise, the signal strength is re-monitored (line 77), either continuously or at selected intervals. FIGS. 2 and 3 also show that an alarm 67 (FIG. 2) co-located with the controller 22a can be connected to the processor 36 to provide an alert whenever the signal strength, S, exceeds the set point plus threshold (Step 69). Alternatively, or in addition to the alarm 67 (FIG. 2), alert information can be placed on a telemetry signal 71 by the processor 36. FIG. 1 shows that the telemetry signal 71 can be combined with the adjusted RF signals 48a-c and transmitted through a telemetry channel in the fiber optic transmission path to the downstream customer 62 or other network node (not shown) or other network termination (not shown).

With reference to FIGS. 2 and 4, a process similar to Steps 66, 68 and 70 (FIG. 3) can be implemented to immediately amplify RF signals having a signal strength below a minimum value. Specifically, when the signal strength, S, falls below the set point minus threshold (FIG. 4), a control signal can be sent to the amplifier 30 (FIG. 2) to amplify the input RF signal 20a.

The flow chart 64 shown in FIG. 3 also illustrates a sequence of steps that can be performed by the processor 36 (FIG. 3) during a leveling operation of the controller 22a. FIG. 4 shows an adjustment of an RF signal passing through the controller 22a during leveling. As shown in FIG. 3, the flow chart 64 begins by storing user inputs and signal strength data from the detector 28 (FIG. 2) into computer readable memory that is accessible by the processor 36 (Step 66). Step 76 shows that the processor 36 (FIG. 2) can function to real-time level RF signals by first sampling the signal strength of an input RF signal over time to calculate a moving window average or some other moving window statistic.

FIG. 4 shows three windows 78a-c (corresponding to window N=1, window N=2 and window N=3 in flow chart 64) with each window having a same time period, L, and beginning at a different start time. Within each window 78a-c a statistic related to the signal strength can be calculated such as signal strength average, median, standard deviation, etc. The calculated statistics can then be used alone or in combination to produce a processor result. For example, FIG. 3 shows the case where the average signal strength is used as the statistic. The average signal strength is calculated for a first window, e.g. window 78a (FIG. 4) in Step 76 and compared to a set point in Step 80. The comparison can yield one of three processor results, illustrated by lines 82a-c. If the average signal strength is equal to the set point (line 82a), the signal is not adjusted, but rather, the processor waits for the completion of the next window (i.e. window 78b in FIG. 4) in Step 84. If the average signal strength exceeds the set point (line 82b), a control signal is sent from the processor 36 (FIG. 2) to the attenuator 32 to attenuate the input RF signal 20a (Step 86) and then the processor 36 waits for the completion of the next window (i.e. window 78b in FIG. 4) in Step 84. If the average signal strength falls below the set point (line 82c), a control signal is sent from the processor 36 (FIG. 2) to the amplifier 30 to amplify the input RF signal 20a (Step 88) and then the processor 36 waits for the completion of the next window (i.e. window 78b in FIG. 4) in Step 84. After the completion of the next window (i.e. window 78b in FIG. 4), Steps 76 and 80 are repeated. After the last full window in the signal, the process is stopped (Step 92). FIG. 4 illustrates the leveling process showing a leveled signal between sample point 74 and sample point 90.

The system 10 shown in FIG. 1 can be incorporated into a bi-directional network. Specifically, signals from the downstream customer 62 or other network node (not shown) or other network termination (not shown) can be processed through the system 10 and output from the system 10 as data stream outputs (not shown) from the source 12 (modem). Also, the system 10 can be incorporated at the downstream customer 62 or other network node (not shown) or other network termination (not shown) to regulate RF signal strength.

FIG. 2 shows that the controller 22a can include an ON/OFF switch 34. For the system 10 (FIG. 1), the ON/OFF switch 34 can be activated locally or remotely to selectively block output of an RF signal from the controller 22a during service and testing procedures, and during a pre-programming of a system configuration. In addition to remotely activating the ON/OFF switch 34, the user inputs 46 (FIG. 2), set points, thresholds, maximum strength values, window parameters, such as window length and start times, and details for calculating and using statistics for leveling, can be input into computer memory that is accessible by the processor 36 remotely (i.e. from another network node or device). For example, a control signal from a remote source can be decoded by the source 12 (FIG. 1) and routed to the processor 36 to allow for remote signal leveling.

While the particular systems and methods for isolating RF signals for transmission over multiple channels on a single transmission path as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A system to isolate Radio Frequency (RF) signals for transmission over a fiber optic transmission path which comprises:
a modem for modulating a plurality of digital signals onto carrier signals to establish a corresponding plurality of RF signals;
a plurality of controllers, wherein each controller receives a respective RF signal from the modem as an input RF signal to adjust a signal strength of the input RF signal toward a predetermined signal strength value, and to output an adjusted RF signal; and
an electrical-to-optical converter for receiving the adjusted RF signals from the controllers to create an optical signal for transmission thereof over the fiber optic transmission path.

2. A system as recited in claim 1 wherein each controller comprises:
a detector for identifying the signal strength of the input RF signal;
a means for establishing a set point, wherein the set point corresponds to the predetermined signal strength value for the input RF signal;
a processor for determining a difference “Δ” between the signal strength of the input RF signal and the set point; and
an attenuator for reducing the signal strength of the input RF signal whenever “Δ” exceeds an upper threshold value “+Δ_{threshold}”.

3. A system as recited in claim 2 wherein each controller further comprises an amplifier for increasing the signal strength of the input RF signal whenever “Δ” falls below a lower threshold value “−Δ_{threshold}”.

4. A system as recited in claim 3 wherein the processor calculates a signal strength statistic for a window corresponding to a time period and uses the statistic to level the signal strength of the input RF signal.

5. A system as recited in claim 4 wherein the signal strength statistic is an average signal strength for the time period.

6. A system as recited in claim 4 wherein the processor calculates a signal strength statistic for a plurality of moving windows, with each window having a same time period, L, and beginning at a different start time, and wherein the processor uses the statistic to level the signal strength of the input RF signal.

7. A system as recited in claim 1 further comprising an alarm connected to at least one controller to provide an alert whenever “Δ” is greater than “Δ_{threshold}”.

8. A system as recited in claim 1 further comprising an alarm connected to at least one controller to provide a report through a telemetry channel in the fiber optic transmission path whenever “Δ” is greater than “Δ_{threshold}”.

9. A system as recited in claim 1 wherein each controller further comprises an ON/OFF switch for selectively blocking output of an RF signal from the controller during service and testing procedures, and during a pre-programming of a system configuration.

10. A system as recited in claim 1 wherein the predetermined signal strength value for an input RF signal can be selectively established for each controller.

11. A system as recited in claim 1 wherein the adjusted RF signals received by the electrical-to-optical converter are combined into a combined signal and wherein the combined signal is a sub-octave signal.

12. A system as recited in claim 1 wherein the system is incorporated into a bi-directional network.

13. A system as recited in claim 1 wherein at least two RF signals have different initial signal strengths.

14. A system for regulating signal strengths of Radio Frequency (RF) signals for combined transmission over a fiber optic transmission path, the system comprising:
a source for outputting a plurality of RF signals;
a signal strength adjusting means operable on each RF signal from the source to reduce interference between the RF signals and for outputting a plurality of strength-adjusted RF signals; and
a means for receiving the strength-adjusted RF signals and for converting the strength-adjusted RF signals into an optical signal for transmission thereof over the fiber optic transmission path.

15. A system as recited in claim 14 wherein the signal strength adjusting means comprises a plurality of controllers, with each controller comprising:
a signal strength detector operable on the input RF signal to produce a detector output;
a means for determining a difference “Δ” between the detector output and a set point, wherein the set point corresponds to the predetermined signal strength value for the input RF signal; and
a means for reducing the signal strength of the input RF signal whenever “Δ” exceeds an upper threshold value “+Δ_{threshold}”.

16. A system as recited in claim 15 wherein each controller further comprises a means for calculating a signal strength statistic for a window corresponding to a time period and for using the statistic to level the signal strength of the input RF signal.

17. A system as recited in claim 15 further comprising an alarm connected to at least one controller to provide a report through a telemetry channel in the fiber optic transmission path whenever “Δ” is greater than “Δ_{threshold}”.

18. A method for regulating signal strengths of Radio Frequency (RF) signals for combined transmission over a fiber optic transmission path, the method comprising the steps of:
outputting a plurality of RF signals from at least one RF signal source;
adjusting a signal strength of each RF signal from the at least one RF signal source to reduce interference between the RF signals;
outputting a plurality of strength-adjusted RF signals;
converting the strength-adjusted RF signals into an optical signal; and
transmitting the optical signal over the fiber optic transmission path.

19. A method as recited in claim 18 wherein the adjusting step comprises the sub-steps of:
detecting a signal strength of an input RF signal;
establishing a maximum strength value for strength-adjusted output RF signals;
comparing the detected signal strength and the maximum strength value; and
attenuating the input RF signal whenever detected signal strength exceeds the maximum strength value.

20. A method as recited in claim 18 further comprising the steps of:
calculating a signal strength statistic for an input RF signal for a window corresponding to a time period; and
using the statistic to level the signal strength of the input RF signal.
